(19) United States
(12) Patent Application Publication
(10) Pub. No.: US 2012/0230697 A1
(43) Pub. Date: Sep. 13, 2012

(54) NOTEBOOK WITH UNIVERSAL CIRCUIT BOARD REALIZED BY THE USE OF OPTICAL FIBER AND THE REALIZATION METHOD

(76) Inventor: Yexun Ji, Shanghai (CN)

(21) Appl. No.: 13/186,685

(22) Filed: Jul. 20, 2011

(30) Foreign Application Priority Data
Mar. 9, 2011 (CN) 201110055507.3

(51) Int. Cl. G02B 6/12; H04B 10/12

(52) U.S. Cl. 398/116; 385/14

(57) ABSTRACT

A notebook with universal circuit board realized by the use of optical fiber and the realization method, based on the fiber optic transmission, the notebook including a core mainboard, a functional mother board, several functional boards electrical connected with the functional mother board, and several expanded functional boards electrical connected with the functional mother board. The core mainboard and said functional mother board are connected by the optical fiber for data transmission. The present invention can be used in a variety of notebooks and realizes universal mainboard, and the already designed functional interface can be directly used. It will help the manufacturing enterprises raise the utilization ratio of universal parts and reduce their operating costs.

### CROSS REFERENCE TO RELATED APPLICATIONS

The present application claims priority from Chinese application CN201110055507.3 filed on Mar. 9, 2011, the content of which is hereby incorporated by reference into this application.

### BACKGROUND

1. Field of the Disclosure

The present invention relates to a notebook with universal circuit board realized by the use of optical fiber and the realization method.

2. Related Art

Optical fiber has been designed with exceptional function of data transmission, and its super fine diameter. Currently, optical fibre has been widely used in all kinds of fields.

Nowadays, the speed of data transfer becomes progressively faster, and there are more and more interfaces with different function, which led to need design for a various of mainboards on notebook with the same module group platform for different functional interfaces. In addition, it is often necessary to redesign the mainboard and the functional interfaces when the functional interfaces have no changes but the Chipsets module group platforms are different. So it will not be able to reuse the ready resources anymore directly.

Moreover, the same kind of considerations seems to be turning against the intention of the manufacturing enterprises to reduce their operating costs by reducing the numbers of different parts and increasing the numbers of universal parts.

### SUMMARY

This invention aims to provide a notebook with a universal circuit board by the use of the optical fiber and the realization method on the basis of the fiber optic transmission. The present invention can be used in a variety of notebooks, and the already designed functional interface can be directly used. It will help the manufacturing enterprises raise the utilization ratio of universal parts and reduce their operating costs.

In order to achieve the above-mentioned purpose, the technical solution of the present invention is to provide a notebook with a universal circuit board by the use of the optical fiber. The notebook comprises a core mainboard, a functional mother board, several functional boards electrical connected with the functional mother board, and several expanded functional boards electrical connected with the functional mother board.

The core mainboard and the functional mother board mentioned above are connected by the optical fiber.

The core mainboard mentioned above includes a core unit, an optical fiber data conversion module of mainboard and an optical fiber data interface of mainboard with electrical connection.

The functional mother board mentioned above includes an optical fiber data interface of the mother board, a control and conversion module, a functional device interface of the mother board with electrical connection.

The optical fiber data interface of the mother board mentioned above is connected with the optical fiber data interface of the mainboard by optical fiber.

The control and conversion module mentioned above includes an optical fiber data conversion module of the mother board and a functional data control module with electrical connection.

The functional board mentioned above includes functional device interface of the board. And said functional device interface of the board is electrical connected with the control and conversion module.

The expanded functional board mentioned above includes a functional extension module and an expanded functional device interface. The functional extension module is electrical connected with the control and conversion module.

The present invention also discloses a method to realize a universal circuit board by the use of the optical fiber, wherein the method includes the following steps:

Step 1. Transmission the data between the core unit and the optical fiber data conversion module of the mainboard;

Step 2. Electrical-optical conversion of the data by the optical fiber data conversion module of the mainboard;

Step 3. Transmission data by optical fiber between the core mainboard and the functional mother board;

Step 4. Optical-electrical conversion of the data signal by the optical fiber data conversion module of the mother board;

Step 5. Transmission the data between the functional data control module and each functional device interface or the functional extension module.

The present invention will help the manufacturing enterprises raise the utilization ratio of the standard universal parts, shorten the product design cycle, and reduce their operating costs.

### BRIEF DESCRIPTION OF THE DRAWINGS

FIG. 1 is a schematic representation of a notebook with a universal circuit board by the use of the optical fiber.

FIG. 2 is a flow chart that illustrates the realization method of a notebook with a universal circuit board by the use of the optical fiber.

FIG. 3 is a schematic representation of the first embodiment.

FIG. 4 is a schematic representation of the second embodiment.

FIG. 5 is a schematic representation of the third embodiment.

### DETAILED DESCRIPTION OF THE EMBODIMENTS

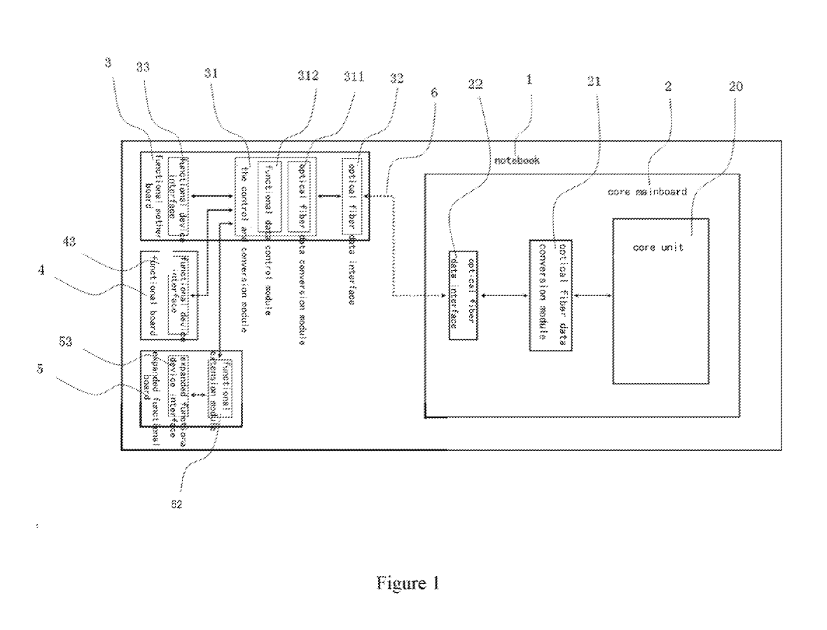

The invention will be disclosed in details with reference to the preferred embodiments according to FIG. 1˜FIG. 5.

As illustrated in FIG. 1, it is a perspective view of the circuit arrangement for a notebook with a universal circuit board by the use of the optical fiber. The present notebook includes a core mainboard 2, a functional mother board 3, several functional boards 4 electrical connected with the functional mother board 3, and several expanded functional boards 5 electrical connected with the functional mother board 3.

The core mainboard 2 and the functional mother board 3 mentioned above are connected by the optical fiber 6 for transferring data.

The core mainboard 2 mentioned above includes a core unit 20, an optical fiber data conversion module 21 of mainboard and an optical fiber data interface 22 of mainboard with electrical connection.

The devices inside the core unit 20 such as CPU and functional module of chip set transfer data to the optical fiber data conversion module 21 on the mainboard. And the core unit 20 is used in data processing.

The optical fiber data conversion module 21 is used in the electrical-optical conversion of the data signal between the optical fiber data interface 22 and the core unit 20.

The functional mother board 3 includes an optical fiber data interface 32 of the mother board, a control and conversion module 31, a functional device interface 33 of the mother board with electrical connection. The functional mother board 3 could be used in converting and processing data which is transmitted by the core mainboard 2, as well as controlling various device interfaces.

The optical fiber data interface 32 of the mother board is connected with the optical fiber data interface 22 of the mainboard by optical fiber 6. And the optical fiber 6 is used for transmitting data between the optical fiber data interface 22 of the mainboard and the optical fiber data interface 32 of the mother board.

The control and conversion module 31 includes an optical fiber data conversion module 311 of the mother board and a functional data control module 312 with electrical connection. The control and conversion module 31 are used to perform the data conversion between optical signals and electrical signals as well as the function conversion and control of the functional device interface 33 of the mother board, functional device interface 43 of the board and the functional extension module 52.

The optical fiber data conversion module 311 of the mother board mentioned above is used to perform the data conversion between optical signals and electrical signals.

The functional data control module 312 mentioned above is used to perform the function control and data transmission to the functional device interface 33 of the mother board, functional device interface 43 of the board and functional extension module 52 after the data conversion between optical signals and electrical signals by optical fiber data conversion module 311 of the mother board.

The functional device interface 33 of the mother board is used to perform the data transmission between the control and conversion module 31 and functional devices.

The functional device mentioned above includes a USB interface equipment, a VGA (D-Sub) interface equipment, an HDMI interface equipment, a Display Port interface equipment, an eSATA interface equipment, an audio interface equipment, an Express Card equipment, network interface equipment, and so on. There will might be some other new interface equipment released in the future.

The functional board 4 mentioned above includes functional device interface 43 of the board. The functional device interface of the board is electrical connected with the control and conversion module 31. The functional board 4 is responsible for the data transmission from the control and conversion module 31. And there are a number of other functional boards being designed according to the actual needs for the internal spaces of the notebook 1.

The functional device interface 43 of the board is used to perform the data transmission between the control and conversion module 31 and functional devices.

The expanded functional board mentioned above comprises a functional extension module and an expanded functional device interface. The functional extension module is electrical connected with the control and conversion module.

The expanded functional board 5 includes a functional extension module 52 and an expanded functional device interface 53. The functional extension module 52 is electrical connected with the control and conversion module 31. The expanded functional board 5 could be used in expanding other functions from the control and conversion module 31. For instance, there might be several USB ports exported from the control and conversion module 31 of the functional mother board, and these ports could be used as the common external interfaces for USB flash disk (which are equal to the functional device interface 33 or 43 or 53 in FIG. 1). Furthermore, it might be a chip of card reader being controlled by USB, and there is a USB wire passing from the functional mother board inside the notebook to the expanded functional board 5, and connecting the expanded functional board 5 (The chip of card reader is equal to the functional extension module 52). The chip of card reader could have all kinds of expanded functions, such as the function of reading SD card, XD card and CF card, while the common port of storage card in notebook is equal to the functional device interface 53. Card reader just is an example, Fingerprint Identifier will be another expanded function realized in the future. It is also an example to be expanded by the USB bus, the Mini-PCIE bus or any other kind of bus will be used in the future.

The functional extension module 52 is used for expanding other functions from the control and conversion module 31, and realizing the data transmission and control along with the expanded functional device interface 53.

The expanded functional device interface 53 mentioned above is used to perform the data transmission between the functional extension module 52 and functional devices.

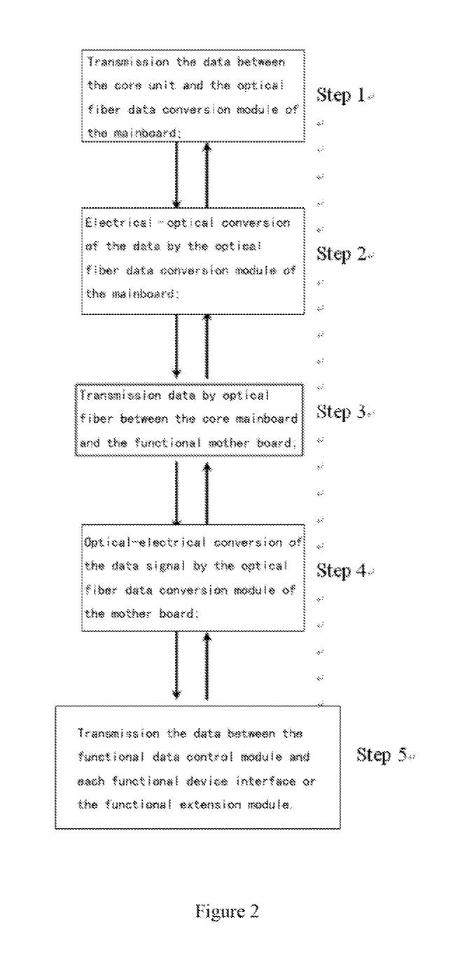

As illustrated in FIG. 2, it is a flow chart that illustrates the realization method to realize a universal circuit board by the use of the optical fiber, wherein the method consists of the following steps:

Step 1. Transmitting the data between the core unit and the optical fiber data conversion module of the mainboard;

Step 2. Electrical-optical conversion of the data by the optical fiber data conversion module of the mainboard;

Step 3. Transmitting data by optical fiber between the core mainboard and the functional mother board;

Step 4. Optical-electrical conversion of the data signal by the optical fiber data conversion module of the mother board;

Step 5. Transmitting the data between the functional data control module and each functional device interface or the functional extension module.

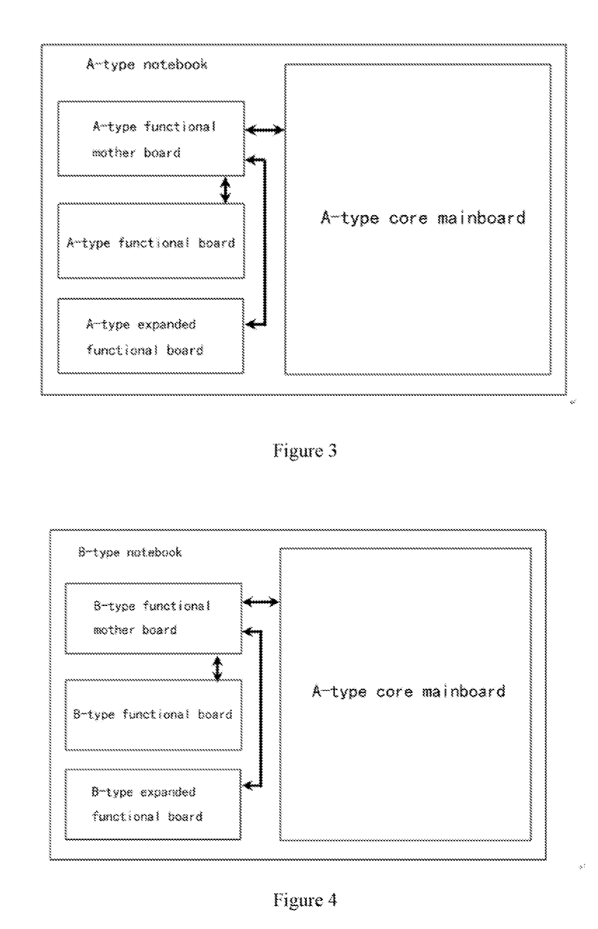

FIG. 3 is a schematic representation of the first embodiment. A-type notebook needs an A-type core mainboard, an A-type functional mother board, an A-type functional board and an A-type expanded functional board.

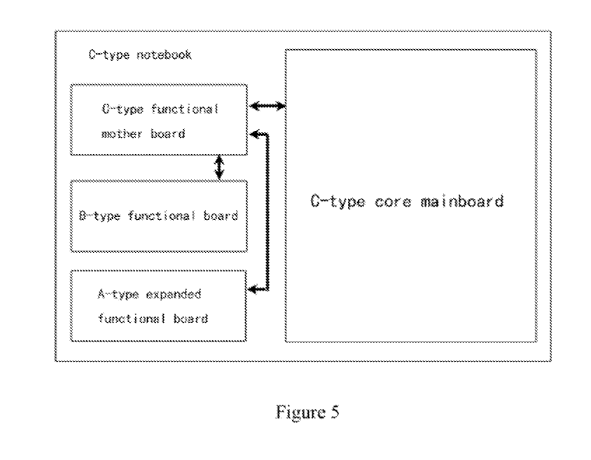

FIG. 4 is a schematic representation of the second embodiment. B-type notebook needs a B-type functional mother board, a B-type functional board, and a B-type expanded functional board. The A-type core mainboard can be used directly without another design. Therefore, it will help the manufacturing enterprises shorten the product design cycle, and reduce their operating costs.

FIG. 5 is a schematic representation of the third embodiment. C-type notebook needs a C-type core mainboard, C-type functional mother board. The B-type functional board and the A-type expanded functional board can be used directly without another design. Therefore, it will help the manufacturing enterprises shorten the product design cycle, and reduce their operating costs.

The specific embodiments realized a universal circuit board which could be used in a variety of notebook.

Although the invention has been described with respect to specific embodiments for a complete and clear disclosure, the appended claims are not to be thus limited, those skilled in the art will appreciate that various other embodiments can be provided without departing from the scope of the invention. Accordingly, the invention is defined only by the claims.

What is claimed is:

1. A notebook with universal circuit board realized by the use of optical fiber, comprising a core mainboard, a functional mother board, several functional boards electrically connected with the functional mother board, and several expanded functional boards electrically connected with the functional mother board,
said core mainboard and said functional mother board are connected by the optical fiber.

2. The notebook with universal circuit board realized by the use of the optical fiber of claim 1, wherein said core mainboard comprises a core unit, an optical fiber data conversion module of the mainboard and an optical fiber data interface of the mainboard with electrical connection.

3. The notebook with universal circuit board realized by the use of the optical fiber of claim 2, wherein said functional mother board comprises an optical fiber data interface of the mother board, a control and conversion module, a functional device interface of the mother board with electrical connection.

4. The notebook with universal circuit board realized by the use of the optical fiber of claim 3, wherein said optical fiber data interface of the mother board is connected with the optical fiber data interface of the mainboard by optical fiber.

5. The notebook with universal circuit board realized by the use of the optical fiber of claim 3, wherein said control and conversion module comprises an optical fiber data conversion module of the mother board and a functional data control module with electrical connection.

6. The notebook with universal circuit board realized by the use of the optical fiber of claim 5, wherein said functional board functional device interface of the board, said functional device interface of the board is electrically connected with said control and conversion module.

7. The notebook with universal circuit board realized by the use of the optical fiber of claim 5, wherein said expanded functional board comprises a functional extension module and an expanded functional device interface, said functional extension module is electrical connected with the control and conversion module.

8. A method to realize a universal circuit board by the use of the optical fiber, wherein said method comprises:
Step 1. transmitting data between the core unit and a optical fiber data conversion module of a mainboard;
Step 2. electrical-optical conversion of the data by the optical fiber data conversion module of the mainboard;
Step 3. transmitting the data by optical fiber between the core mainboard and a functional mother board;
Step 4. optical-electrical conversion of the data by an optical fiber data conversion module of the mother board;
Step 5. transmitting the data between the functional data control module and each functional device interface or the functional extension module.
